(19) United States
(12) Patent Application Publication
(10) Pub. No.: US 2017/0285930 A1
(43) Pub. Date: Oct. 5, 2017

(54) DOCUMENT CONTENT REPLAY

(71) Applicant: Microsoft Technology Licensing, LLC., Redmond, WA (US)

(72) Inventors: Sarah Sykes, Redmond, WA (US); Jason H. Hartman, Woodinville, WA (US); Ian William Mikutel, Redmond, WA (US)

(73) Assignee: Microsoft Technology Licensing, LLC., Redmond, WA (US)

(21) Appl. No.: 15/237,425

(22) Filed: Aug. 15, 2016

Related U.S. Application Data
(60) Provisional application No. 62/317,441, filed on Apr. 1, 2016.

(51) Int. Cl. G06F 3/0485; G06F 17/24; G06F 17/27; G06F 3/0482

(52) U.S. Cl. CPC G06F 3/04855; G06F 3/0482; G06F 17/241; G06F 17/2705; G06F 17/242

(57) ABSTRACT

Incremental replay of content in an electronic workspace canvas is provided. Content can be selected for replay. Replay of the content can be played forward or backward to hide or reveal content. Interaction with and adding or modifying content is enabled while it is being replayed. Annotations may be added to the replayed content and set for display at specific times or positions during the replay order.

### CROSS-REFERENCES TO RELATED APPLICATIONS

The present application claims benefit from U.S. Provisional Application No. 62/317,441 filed on Apr. 1, 2016 and titled “DOCUMENT CONTENT REPLAY” which is herein incorporated by reference in its entirety.

### BACKGROUND

A user may create content via a productivity application for presentation to others, either in real time or in advance. As an example, a teacher may create a lesson plan including various math problems, or may work a number of math problems in the classroom to demonstrate to students how to solve the math problems. Oftentimes, such as with the above example, content is created in a step-by-step manner, wherein presenting or revealing the content in a step-by-step manner provides context and insight to the user that may otherwise not be understood.

Additionally, a user may add content to a document for later review. As an example, a student may complete a homework assignment, such as fill-in-the-blank worksheet, and may later want to review the homework assignment when studying for a test. The user may wish to self-test by hiding the answers and then later revealing the answers for checking correctness.

Document content is input via various methods, such as from input devices such as mice, keyboards, remote controls, and the like, or from natural user input (NUI) methods including those relying on speech recognition, touch and stylus recognition, gesture recognition both on screen and adjacent to the screen, air gestures, head and eye tracking, voice and speech, vision, touch, hover gestures, and machine intelligence.

Using digital ink input in an application produces a digital artifact which, although “handwritten,” may be stored, copied, transmitted, edited, and annotated. In an educational environment, for example, applications incorporating digital ink input are oftentimes used as an educational resource for taking notes, to create lesson plans, for completing homework assignments, and the like.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Systems and methods are provided herein to enable improved usability of productivity applications that enables incremental replay of document content without the need for a user to intentionally structure the content in an ordered fashion. An electronic workspace internally represents its displayed content in a graph. Nodes are associated with types of content. Nodes that represent the document content have associated view elements that can know how to render that node type.

When the electronic workspace wants to render a page, it walks the graph and renders the view elements. A time travel effect can be achieved by traversing the graph in order of structural hierarchy or in order of when items were added, and marking the relevant items as objects to be rendered, hidden, or rendered semi-transparently, and then re-displaying the relevant portion of the screen. Traversing can be limited to the current viewport, or the current selection state of the nodes, or other characteristics. By employing the present disclosure, an improved user experience is provided and less memory and fewer processing resources are expended to provide incremental replay of document content.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 illustrates a block diagram of a system enabled to accept document content inputs and to enable incremental revealing or hiding of content on a canvas in an electronic authoring environment;

FIG. 2 illustrates an example entry point to replay content;

FIG. 3 illustrates an example prompt to select content in an area of interest for replay;

FIG. 4 illustrates an example selection of content made by a user;

FIG. 5 illustrates an example incremental revealing of content displayed in the selected area of interest and an example display of play commands for controlling incremental revealing or hiding of the content;

FIGS. 6-9 illustrate an example incremental hiding of content in a selected area of interest;

FIG. 10 illustrates an example selection made by a user to replay all content displayed on the canvas;

FIG. 11 illustrates an example incremental revealing of content on the canvas and an example display of play commands for controlling incremental revealing or hiding of the content;

FIG. 12 illustrates an example pane option;

FIG. 13 illustrates an example annotation added by a user during replay of content;

FIGS. 14-16 illustrate an example incremental revealing of strokes for drawing a Japanese Kanji character;

FIGS. 17-18 illustrate an example incremental revealing of a question and answer;

FIG. 19 is a flowchart showing general stages involved in an example method for providing document content replay;

FIG. 20 is a block diagram illustrating physical components of a computing device with which examples may be practiced;

FIGS. 21A and 21B are block diagrams of a mobile computing device with which aspects may be practiced; and

FIG. 22 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Systems and methods are provided herein for enabling incremental replay of document content without the need for a user to intentionally structure the content in an ordered fashion.

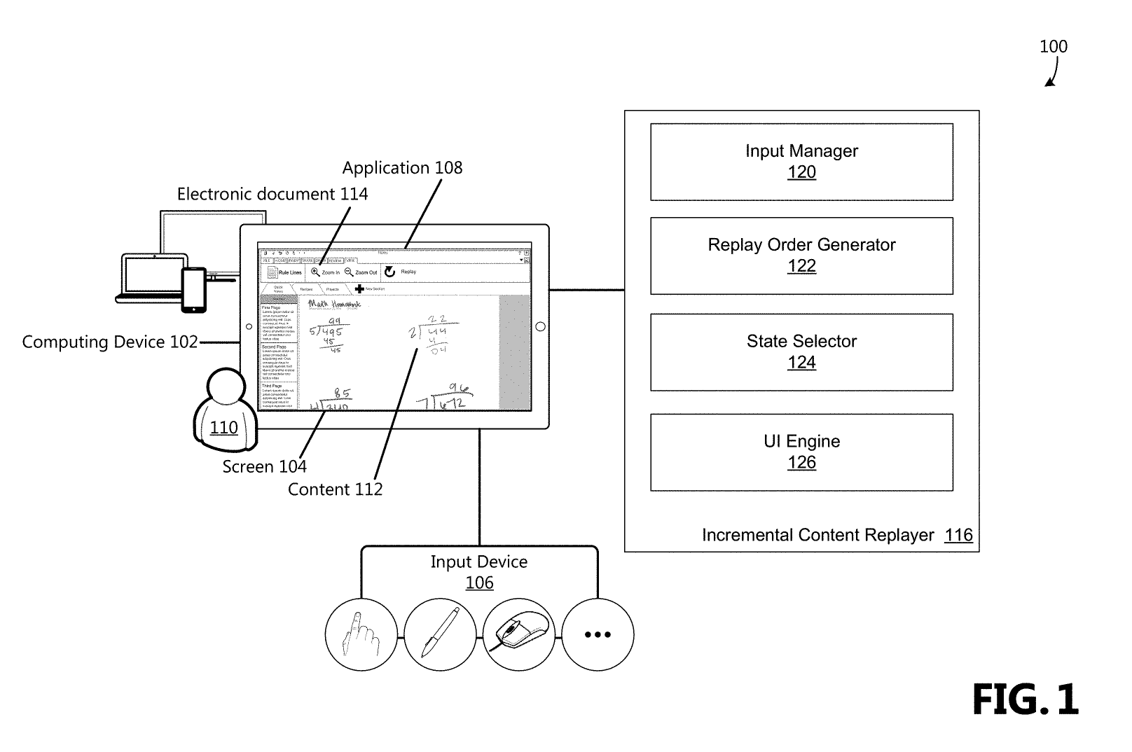

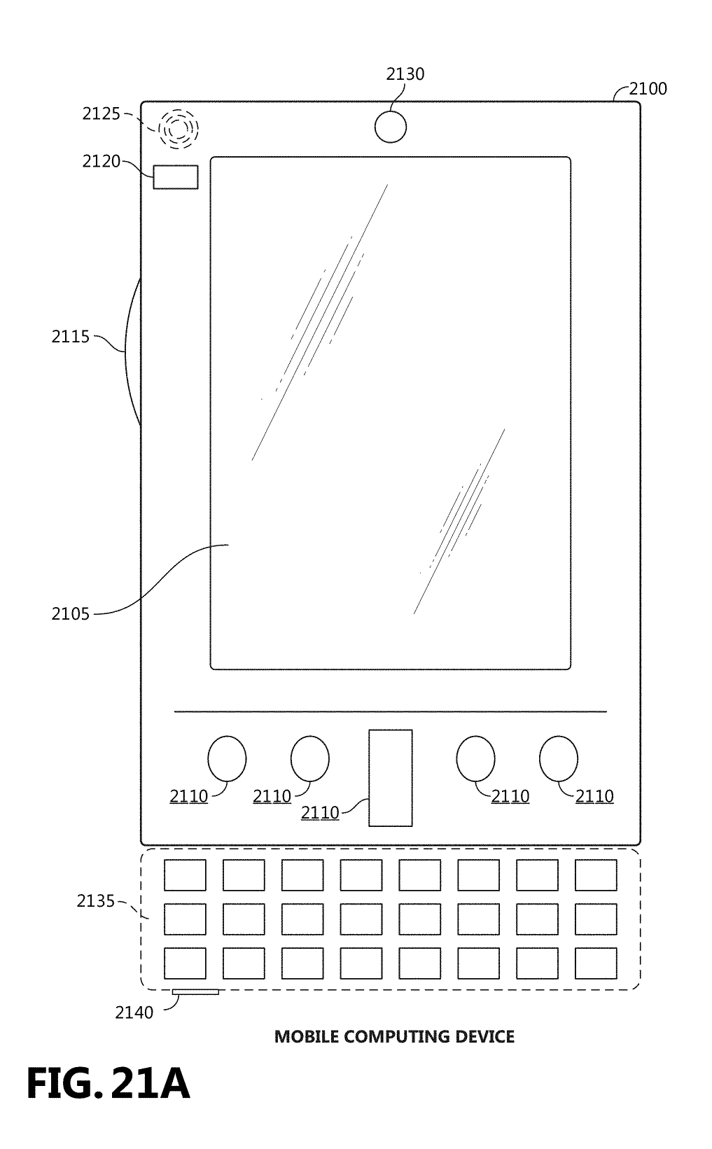

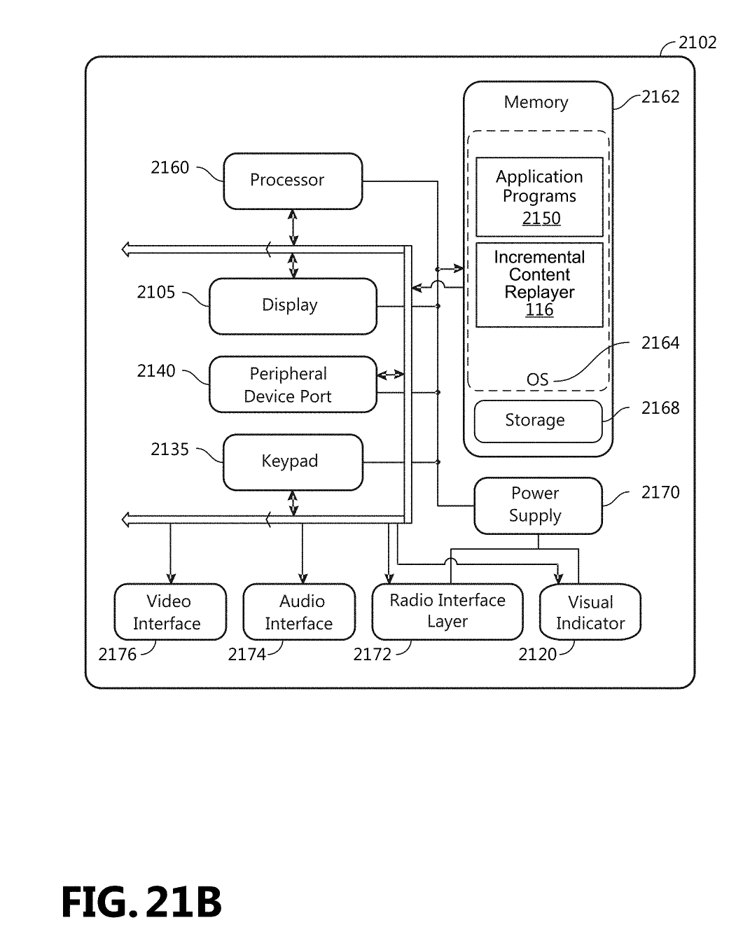

With reference now to FIG. 1, a block diagram of one example environment 100 in communication with an incremental content replayer 116 is shown. As illustrated, the example environment includes a computing device 102. The computing device 102 illustrated in FIG. 1 is illustrated as a mobile computing device (e.g., a tablet computer or a mobile communication device); however, as should be appreciated, the computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, or other type of computing device) for executing applications 108 for performing a variety of tasks. The hardware of these computing devices is discussed in greater detail in regard to FIGS. 21, 22A, 22B, and 23.

A user 110 may use an application 108 on the computing device 102 for a variety of tasks, which may include, for example, to write, calculate, draw, take and organize notes, prepare and organize presentations, send and receive electronic mail, make music, and the like. Applications 108 may include thick client applications 108, which may be stored locally on the computing device 102, or may include thin client applications 108 (i.e., web applications) that reside on a remote server and accessible over a network, such as the Internet or an intranet. A thin client application 108 may be hosted in a browser-controlled environment or coded in a browser-supported language and reliant on a common web browser to render the application 108 executable on the computing device 102. According to an aspect, the application 108 is a program that is launched and manipulated by an operating system, and manages content 112 within an electronic document 114 and published on a display screen 104.

The content 112 in an electronic document 114 may vary according the program used to provide the electronic document 114. The content 112 may comprise one or more objects present or imbedded in the electronic document 114 including, but not limited to: text (including text containers), numeric data, macros, images, movies, sound files, and metadata. According to one example, the content 112 includes a plurality of digital strokes, sometimes referred to herein as “inking” input, wherein a stroke is a data object that is collected from a pointing device, such as a tablet pen, a finger, or a mouse. The stroke can be created and manipulated programmatically, and can be represented visually on an ink-enabled element, such as the ink canvas. In some examples, a stroke contains information about both its position and appearance.

In various aspects, the data comprising the content 112 are stored in an elemental form by the electronic document 114, such as in Extensible Markup Language (XML) or Java Script Object Notation (JSON) elements or another declaratory language interpretable by a schema. The schema may define sections or content item via tags and may apply various properties to content items via direct assignment or hierarchical inheritance. For example, an object comprising text may have its typeface defined in its element definition (e.g., “<text typeface=garamond>example text</text>”) or defined by a stylesheet or an element above the object in the document's hierarchy from which the element depends.

With reference still to FIG. 1, an application 108 includes or is in communication with an incremental content replayer 116, operative to provide incremental content replay. In one example, the computing device 102 includes an incremental content replayer application programming interface (API), operative to enable the application 108 to employ incremental content replay via stored instructions.

According to aspects, the incremental content replayer 116 includes: an input manager 120; a replay order generator 122; a state selector 124; and a UI engine 126. The input manager 120 is illustrative of a software module, system, or device operative to receive a selection input. According to aspects, the selection input includes a physical act or motion performed on or by an input device 106 (e.g., finger, pen/stylus, mouse) at a position of a user-controlled cursor (such as a mouse cursor or touch-point on a touch-screen interface) that is interpreted as a selection interaction. According to an example, the input device 106 is a pointing device used to specify a position (e.g., x, y coordinates) on a graphical user interface (GUI), and manipulate on-screen objects.

According to one aspect, the input manager 120 is operative to receive an indication of a selection to replay content, for example, via a selection of a functionality control. According to another aspect, the input manager 120 is operative to receive a selection of content for incremental replay. In one example, the input manager 120 identifies the position of the user-controlled cursor (e.g., mouse cursor or touch-point) to determine an area of interest 402, and determine if any content elements are within the area of interest 402.

According to an aspect, the replay order generator 122 is illustrative of a software module, system, or device operative to establish a replay order of content elements that have been authored within the area of interest 402. According to an example, the replay order generator assigns a replay-order value to each content element. In one example, the replay-order value is based on the content element's structural hierarchy in back-to-front order (i.e., z-order). In one example, ordering may be implicit in the existing structure, and identification of the structural hierarchy is performed by the replay order generator 122. In another example, the replay-order value is based on a timestamp associated with a modification (e.g., input or content authoring) of the content element. Accordingly, newer or more recently added input has a higher replay-order value, and older or previously added input has a lower replay-order value. In another example, replay order value is based on a combination of structural hierarchy and timestamp association.

The state selector 124 is illustrative of a software module, system, or device operative to determine a selected or implicitly selected replay mode. In some examples, the determination is made based on a selected command. If the replay mode is determined to be backward, the state selector 124 is operative to identify the foremost content element that is currently displayed (in the area of interest 402) according to the replay-order value, and change the display state of the content element to hide. If the replay mode is determined to be forward, the state selector 124 is operative to identify the backmost content element according to the replay-order value, and change the display state of the content element to be shown.

UI engine 126 is illustrative of a software module, system, or device operative to update the GUI to according to the state change. For example, the UI engine 126 is operative to update the GUI to incrementally display content in a backward or forward direction.

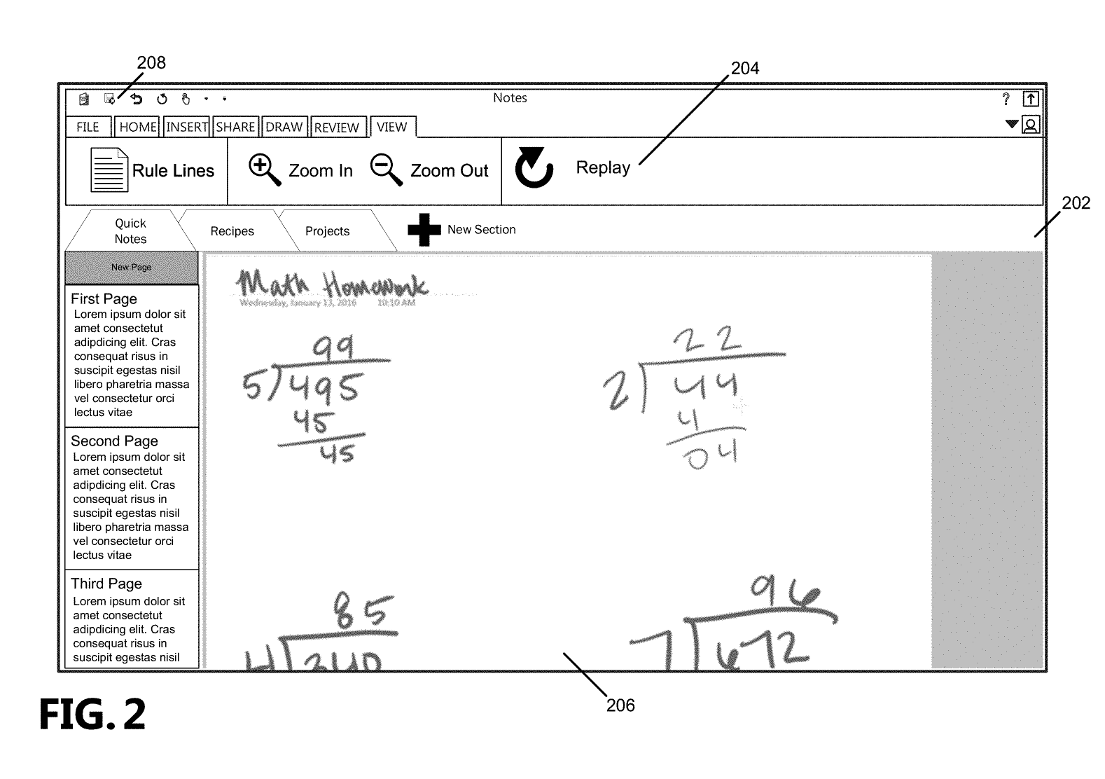

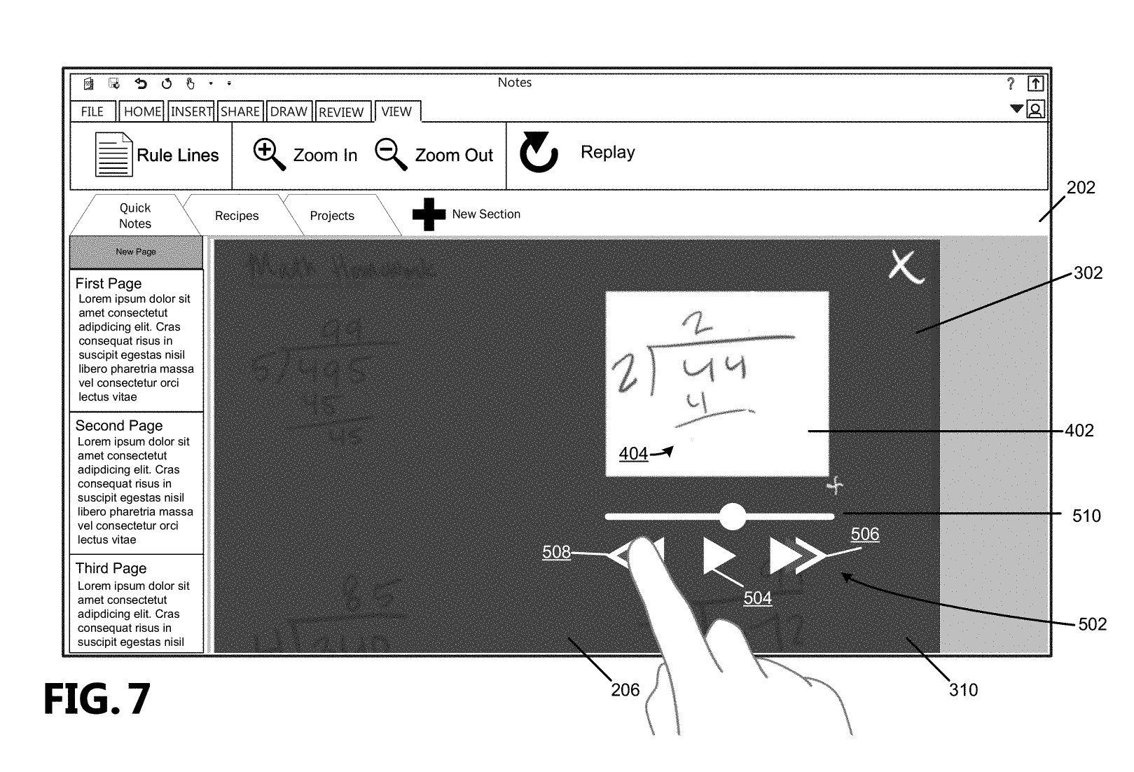

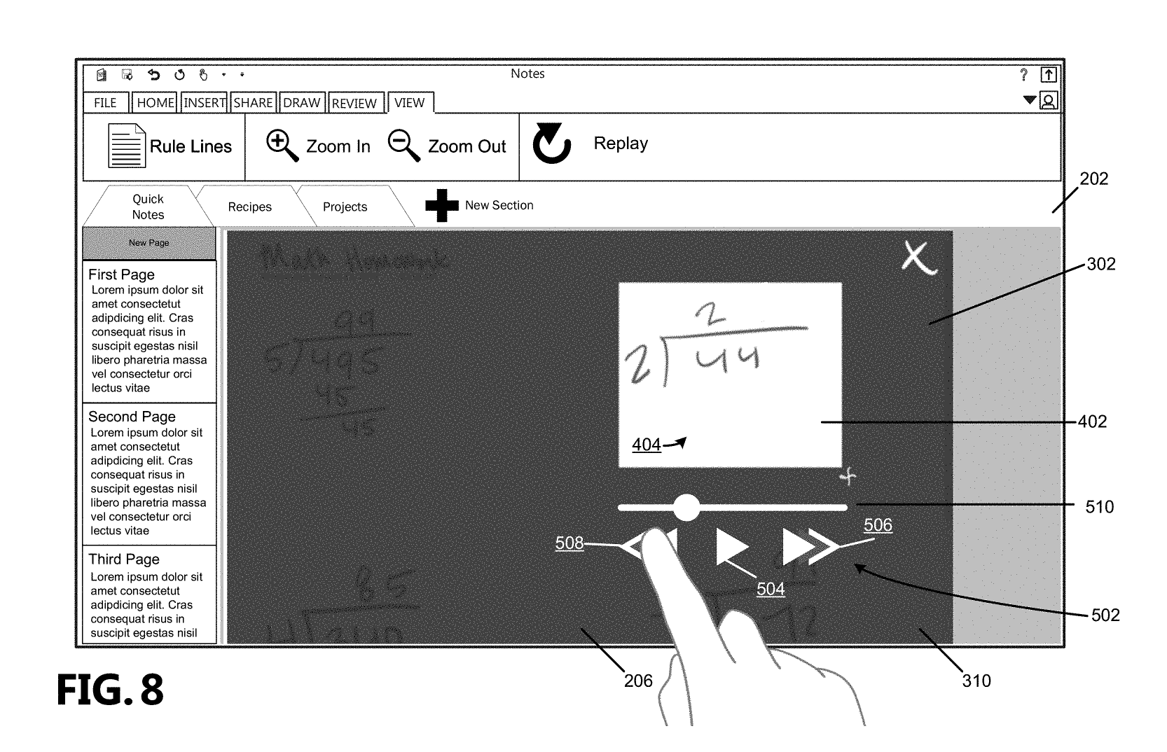

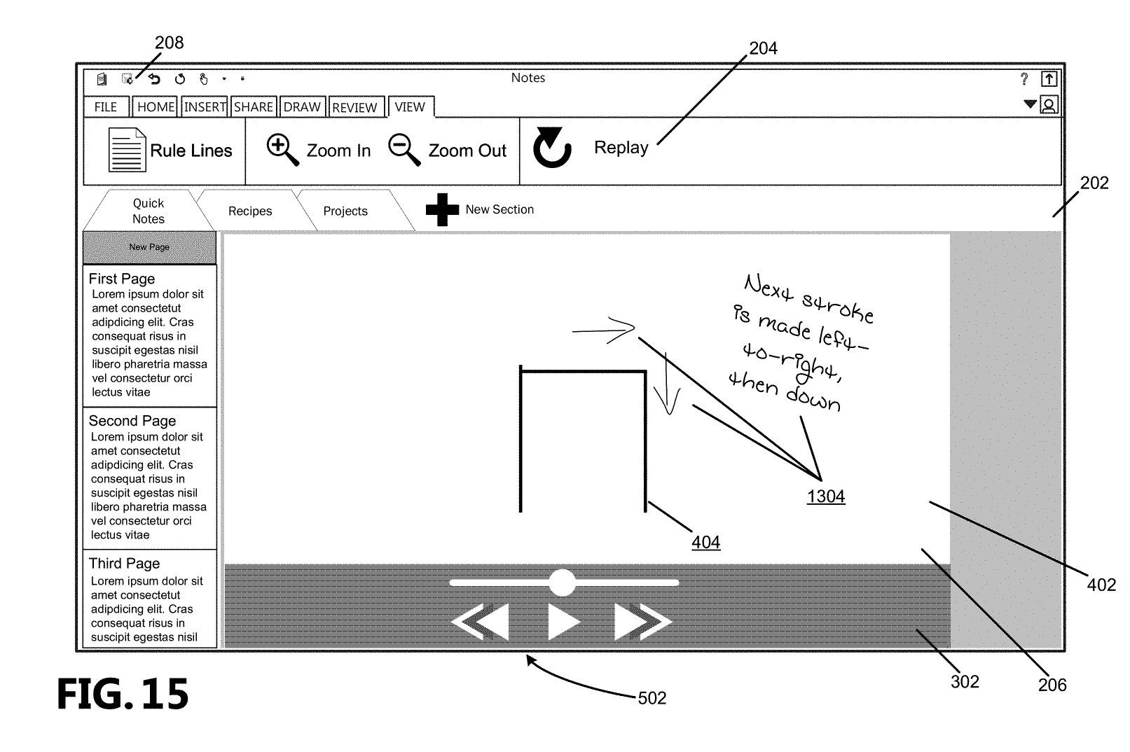

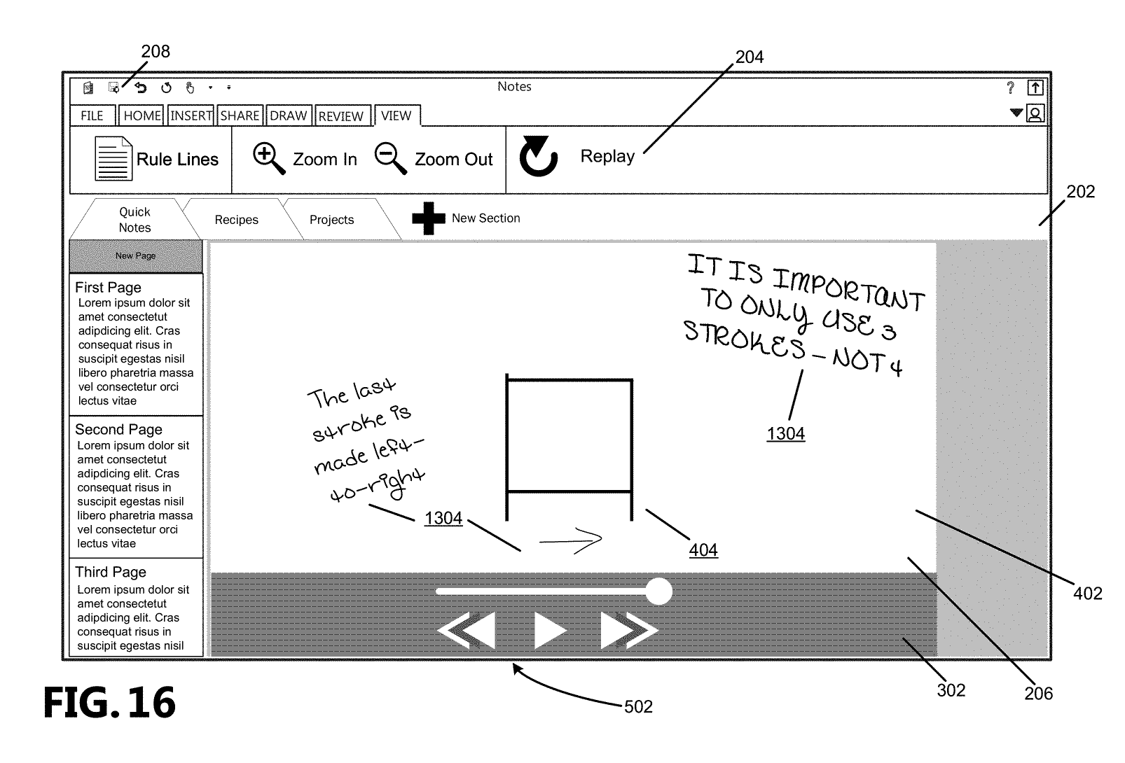

Some various example scenarios in which it may be beneficial to a user to incrementally replay content include: a teacher lecturing from prepared content in front of a class; a teacher revisiting an item that a student has a question about during a lecture; a teacher reviewing a student's work and trying to understand the student's thinking/processing; and students testing/quizzing themselves to study. FIGS. 2-18 show various GUI examples illustrating various features of aspects of incremental replay of content. As will be appreciated, the examples illustrated in FIGS. 2-18 are non-limiting illustrations; other GUIs with different elements and arrangements thereof may be used in conjunction with the present disclosure. An example of a situation in which it may be beneficial to a user to incrementally replay content includes learning to work math problems. FIGS. 2-13 show various examples of replay of content involving math problems. With reference now to FIG. 2, an illustration showing an example entry point 204 to replay content is provided. As illustrated, a GUI 202 including a page displayed on a canvas 206 displayed in an application window functionality interface 208. According to one example, the canvas 206 is a freeform area in which elements may be inserted into their own movable containers. According to an aspect, an entry point 204 for content replay is provided. In the illustrated example, the entry point 204 is labeled as “Replay,” and is displayed in a command bar that organizes the features of an application into a series of tabs at the top of the application window functionality interface 208.

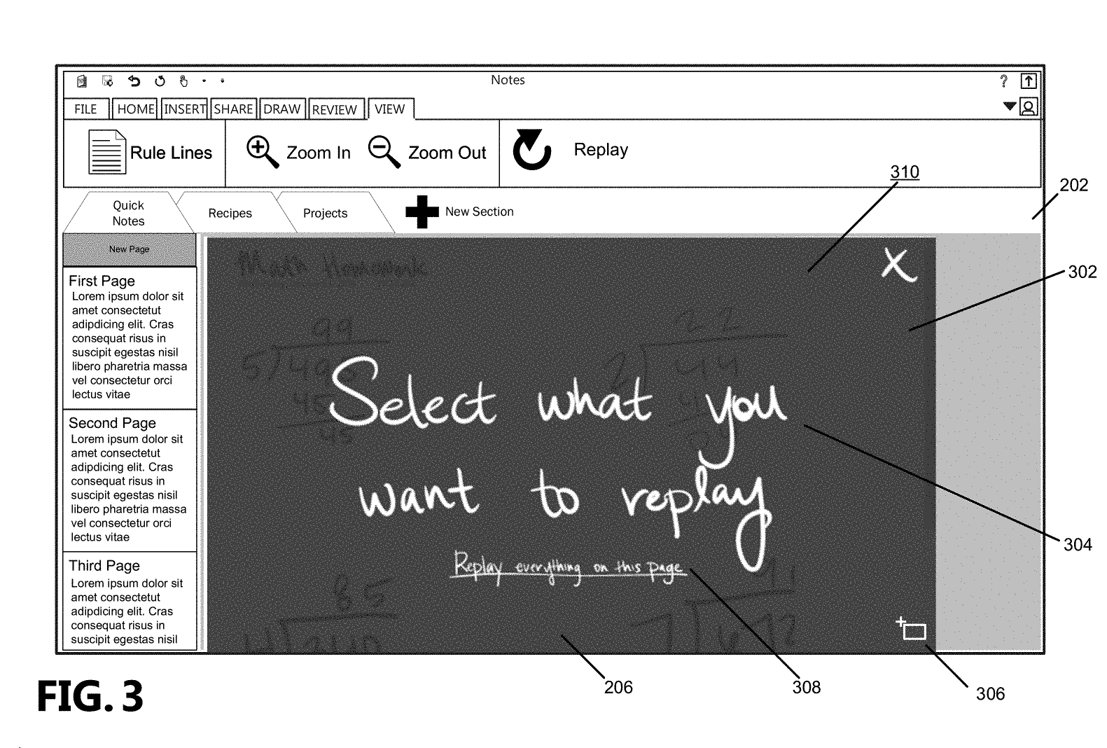

Upon selection of the entry point 204, and with reference now to FIG. 3, a canvas overlay 302 is added over the displayed canvas 206 area. For example, the canvas overlay 302 is displayed over unselected content 310 (e.g., content that has not been selected for replay), wherein a hint of the unselected content is visible. In one example, the canvas overlay 302 has an opacity value, and unselected content 310 below the overlay is somewhat visible through the canvas overlay 302.

According to examples, the canvas overlay 302 provides a prompt 304 that instructs the user to select an area of interest 402 for replay of the content within the selected area of interest 402. In one example, the cursor becomes a marquee selector 306 that enables the user to select content displayed on the canvas 206 for replay. In another example, a “replay everything on this page” functionality command 308 is provided that enables the user to select to replay all the content currently displayed on the canvas 206. If another page is selected, the unselected content 310 displayed below the canvas overlay 302 changes to the content on the newly-selected page.

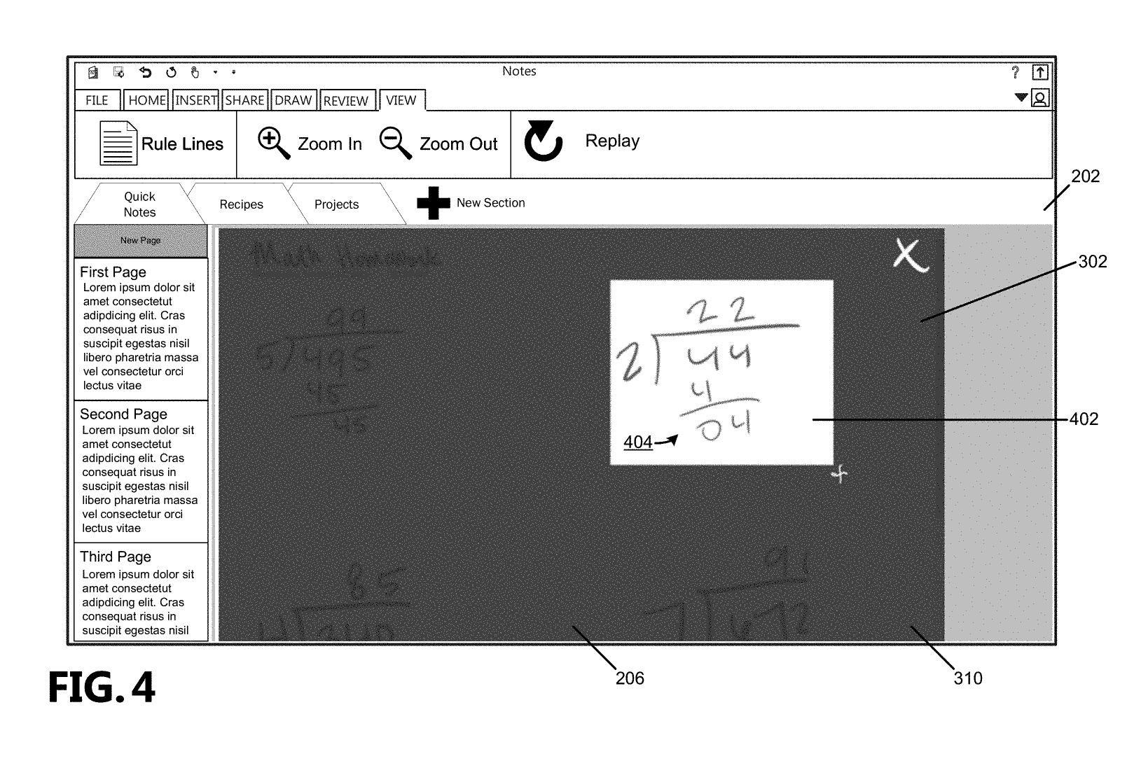

With reference now to FIG. 4, an illustration showing an example of selection of content (i.e., replay content 404) within a selected area of interest 402 made by a user is shown. For example, the user uses the marquee selector 306 to select content to replay. In one example, the prompt 304 and “replay everything on this page” functionality command 308 are removed from the display when the user begins to make a selection. According to another example, the canvas overlay 302 remains displayed over the unselected content 310.

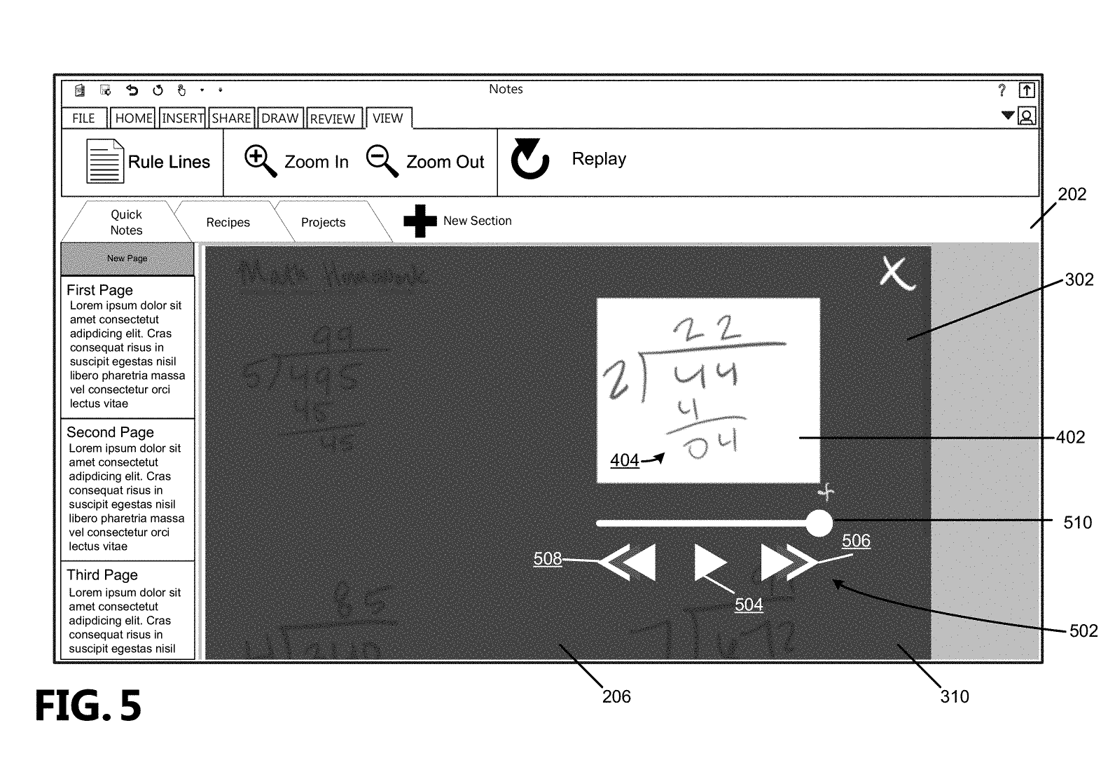

According to an aspect and with reference now to FIG. 5, when an area of interest 402 is selected, various replay commands 502 are provided that enable the user to control the replay content 404. In one example, the replay commands 502 include a multimedia-like (audio/video) scrub bar 510, a rewind command 508, a play/pause command 504, and a fast forward command 506. According to an example, when a selection of the play/pause command 504 is made, strokes are divided into appropriate stroke lengths to avoid jarring jumps in the appearance of ink on the canvas, and each stroke or segment of a stroke is displayed incrementally according to a predetermined or adjustable time interval. According to another example, when a selection of the rewind command 508 or fast forward command 506 is received, with each click or selection of the command, the content is stepped backward or forward one object or stroke or segment of a stroke. In one example, smart grouping may be used to incrementally hide or reveal one number or letter with each click or selection. According to another example, the scrub bar 510 is a control that allows the user to move forward or backward in the replay of the selected content (replay content 404) by dragging a handle or slider or via keyboard input, or to jump to a specific point in time or to a specific object/stroke with a selection along the scrub bar 510 progress bar or timeline. The scrub bar 510 updates visually to show the replay content's 404 replay progress.

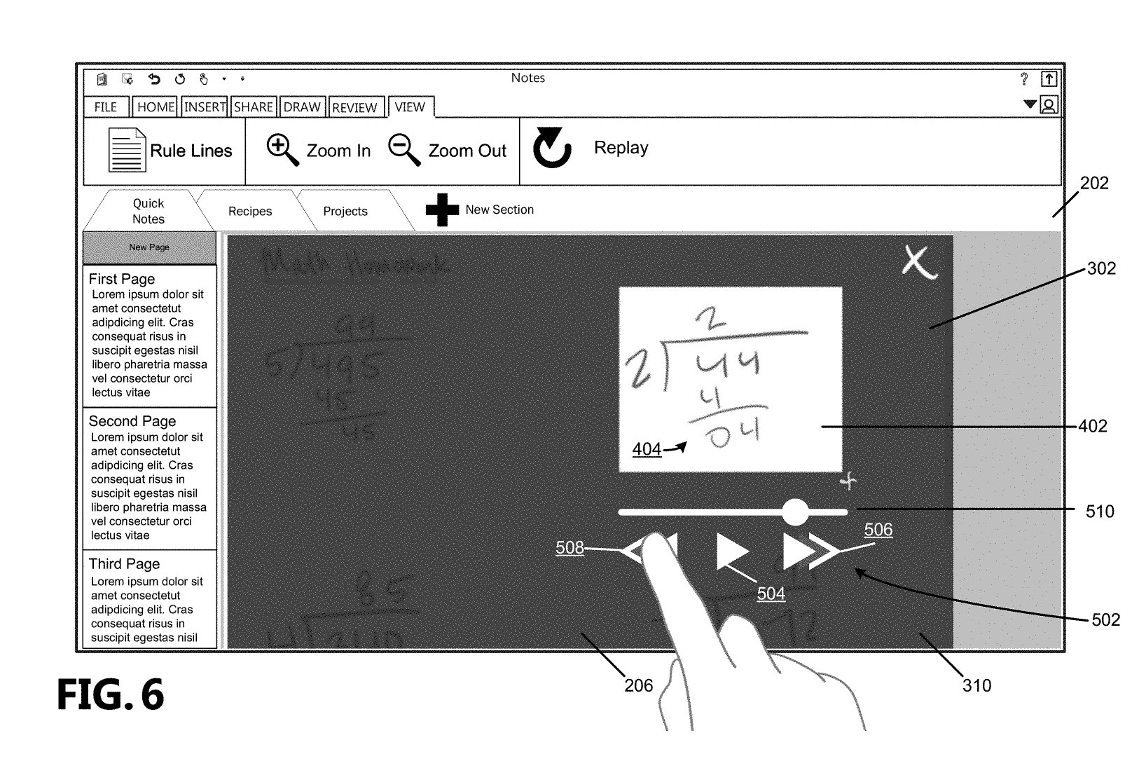

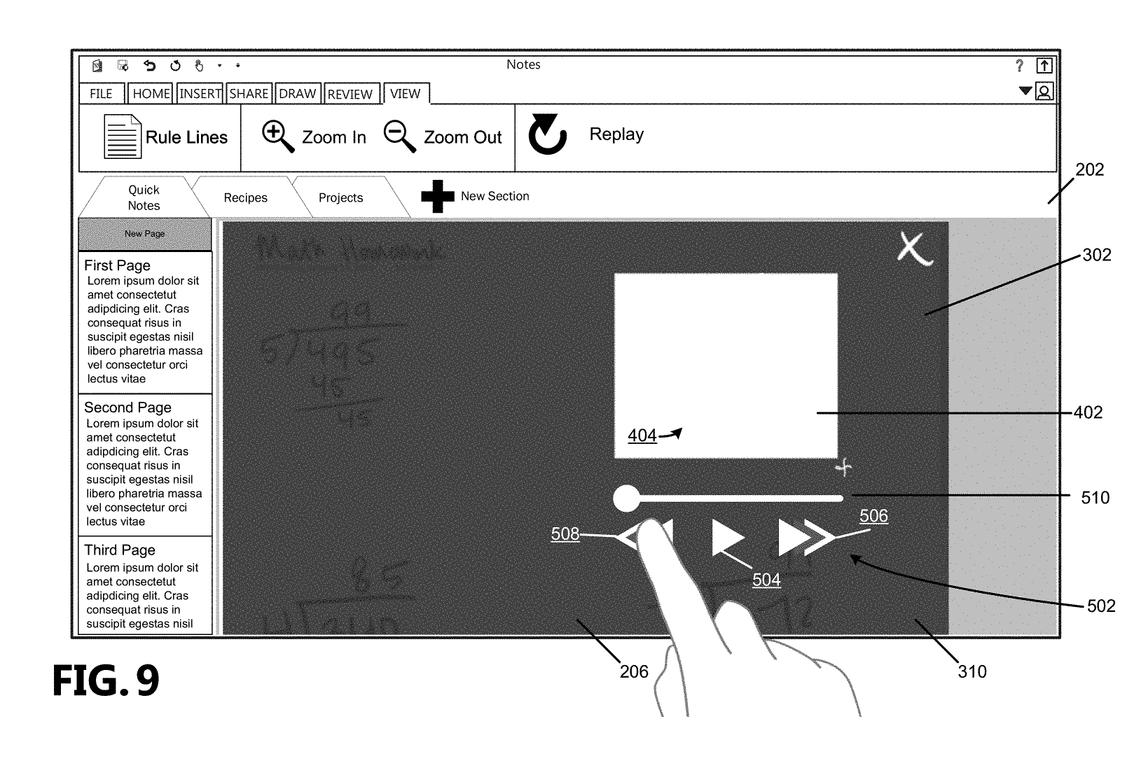

As an example and as illustrated in FIG. 5, the user selects to replay the replay content 404 in backward order, for example, by selecting the rewind command 508. When replay content 404 is replayed in backward order, objects or strokes of the replay content 404 are incrementally hidden starting with the topmost or highest z-order valued object/stroke currently displayed. In one example, prior to selecting the rewind command 508, the user may first move the handle or slider of the scrub bar 510 or first step forward through the content. FIGS. 6-9 show the incremental backward stepping of objects/strokes of the replay content 404 with each successive selection of the rewind command 508 until all objects/strokes are hidden and removed from display (FIG. 9).

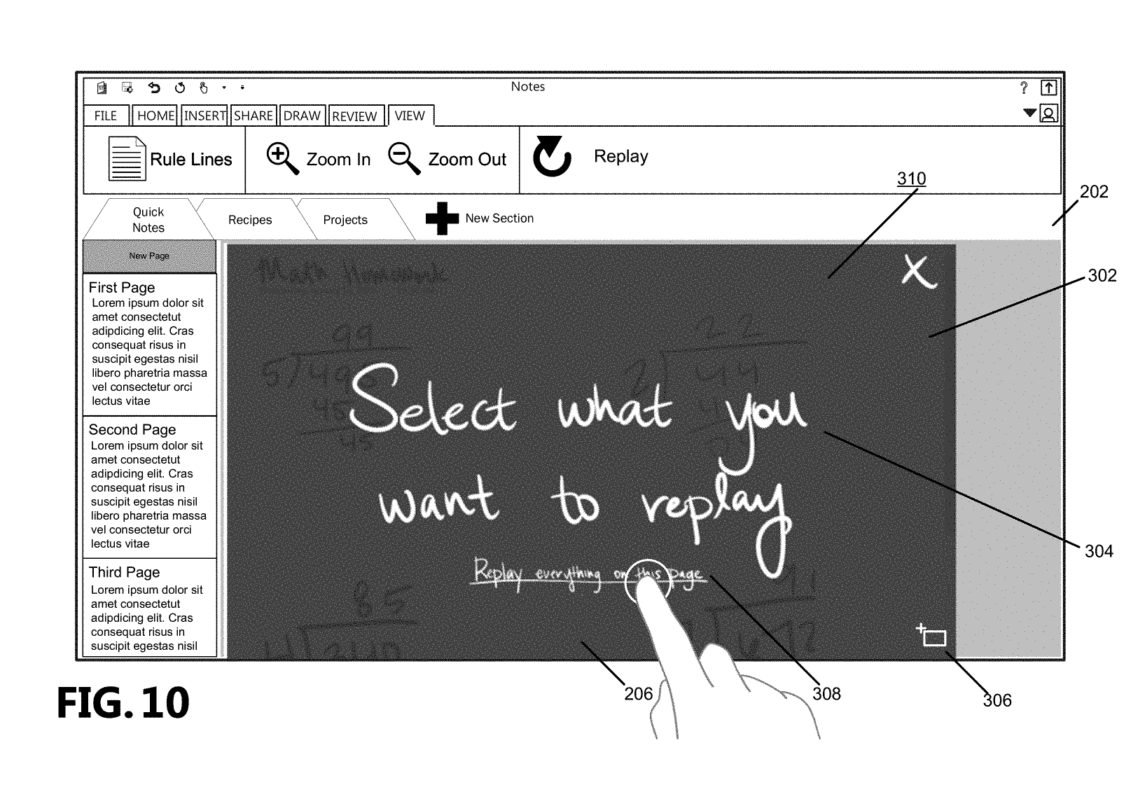

With reference now to FIG. 10, an example of a selection of the “replay everything on this page” functionality command 308 is illustrated. As described above, when the “replay everything on this page” functionality command 308 is selected, all the content visible on the canvas 206 is selected to be replayed. In one example, objects/strokes that are cut off but still visible are included in the replay content 404. In another example, the canvas 206 pans to where the first stroke/object on the page was placed, and all strokes fully visible in that window play. Once a new stroke is partially or fully out of view, the canvas 206 pans to continue incrementally replay the replay content 404. In one example, the zoom level stays where the user set it prior to executing the replay. In another example, the canvas zooms in on the currently replaying replay content 404 during the replay.

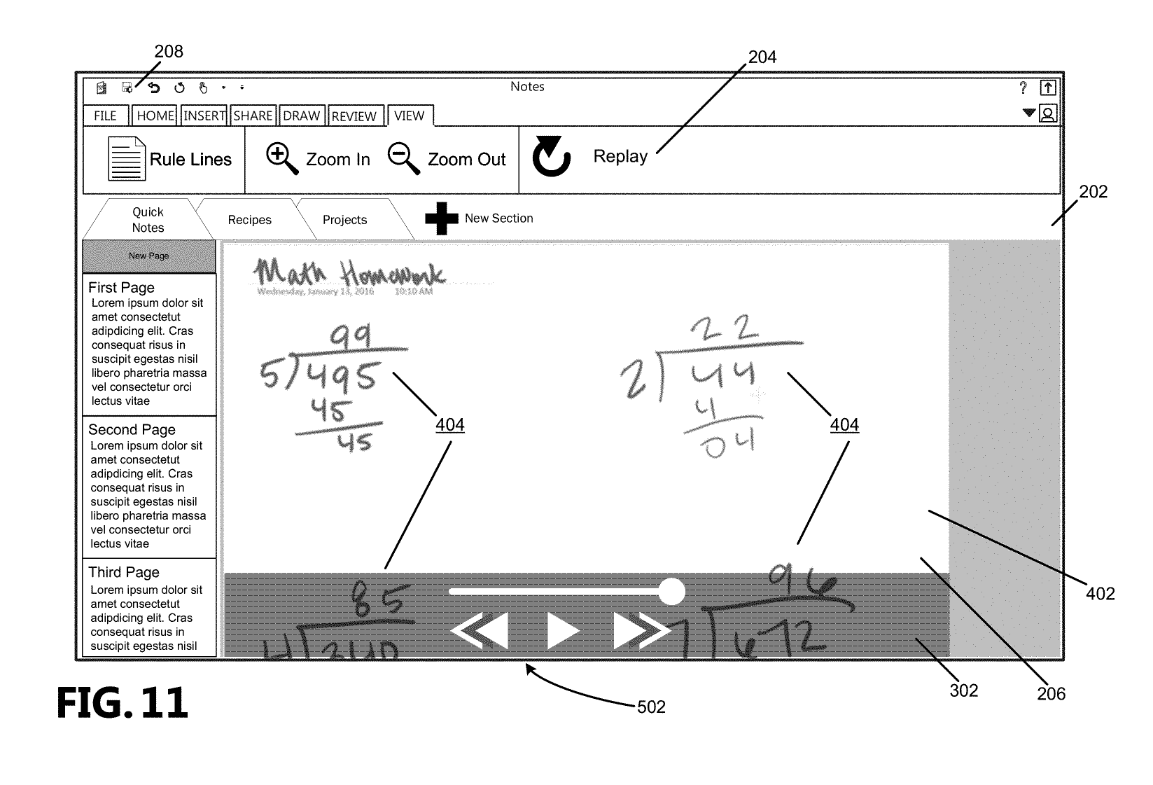

FIG. 11 shows an example display of incremental revealing of replay content 404 on the canvas 206 in response to a selection to replay all content visible on the canvas 206. According to an example and as illustrated in FIG. 11, a small canvas overlay 302 may remain displayed and anchored to an edge of the application window functionality interface 208, and the various replay commands 502 are provided that enable the user to control the replay content 404.

Similarly to when a portion of displayed content is selected for replay as described above with respect to FIG. 5, when a selection of the play/pause command 504 is made, strokes are divided into appropriate stroke lengths to avoid jarring jumps in ink, and each stroke or segment of a stroke is displayed incrementally according to a predetermined or adjustable time interval. According to another example, when a selection of the rewind command 508 or fast forward command 506 is received, with each click or selection of the command, the content is stepped backward or forward one stroke or segment of a stroke. In one example, smart grouping may be used to incrementally hide or reveal one number or letter with each click or selection. According to another example, the user may use the scrub bar 510 to control forward or backward replay of the selected content (replay content 404) by dragging a handle or slider, or via keyboard input. In another example, the user may choose to jump to a specific point in time or to a specific object/stroke by selecting along the scrub bar progress bar or timeline. The scrub bar 510 updates visually to show the replay content's 404 replay progress.

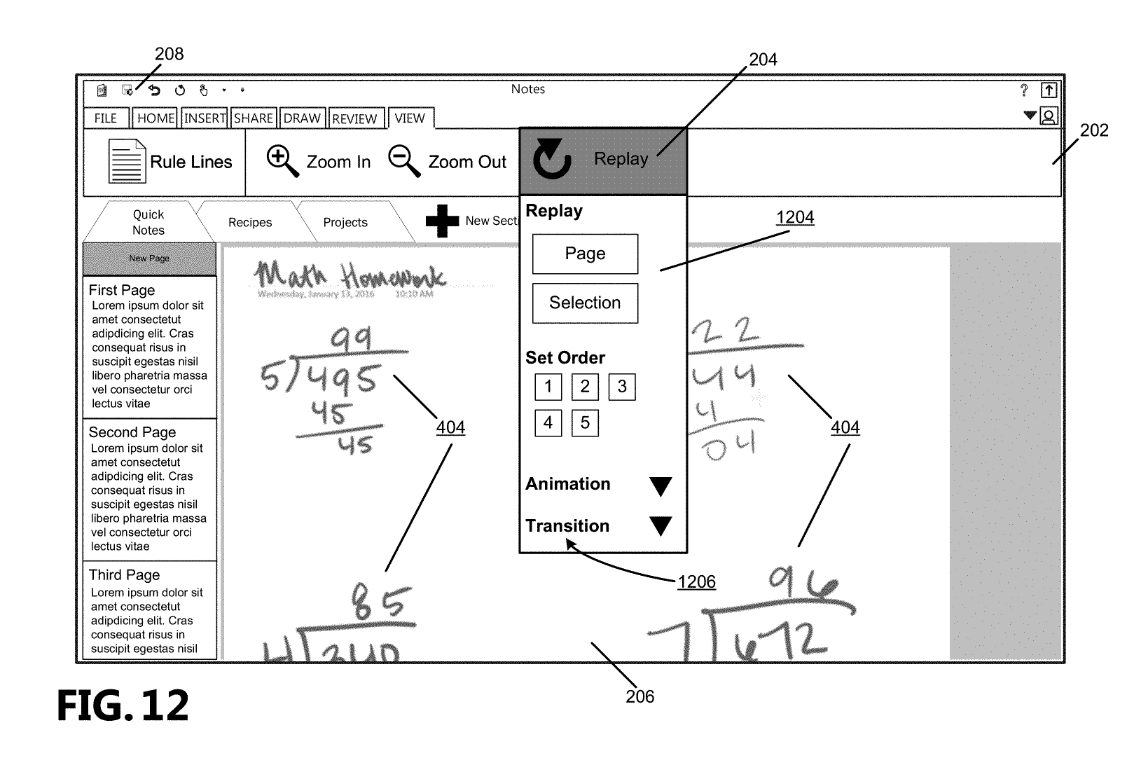

FIG. 12 illustrates an example pane option. For example, a pane 1204 may be displayed that includes functionalities 1206 for enabling the user to select, set numbers, animations, or transitions to move through replay content 404. For example, the pane option functionalities 1206 enable the user to have more control over how replay content 404 is revealed or hidden. As will be appreciated, content elements may be hidden by removing them from display from the GUI, but may also include applying a reduced visibility effect on the content element (e.g., graying the content element out, applying a semi-transparent effect to the content element, decreasing a size of the content element).

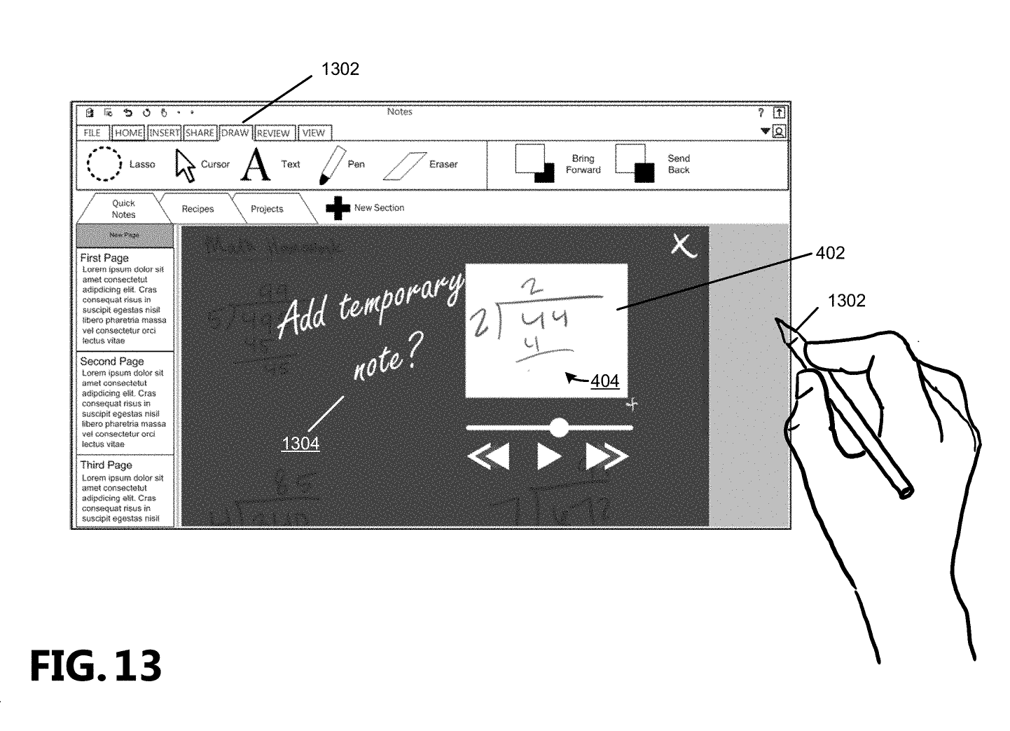

According to an aspect and as illustrated in FIG. 13, the user is enabled to interact with the replay content 404 while it is being replayed, such as to add a new content element as an annotation 1304 on top of the replay content 404 to help illustrate a point. In one example, an annotation 1304 added during replay is sandwiched into the replay order (e.g., the z-order). For example, the annotation 1304 is added on top of the last-displayed stroke, and is assigned a z-order value incrementally higher than the z-order value of the last-displayed stroke in the replay content 404. In another example, an annotation 1304 added during replay is added to the end of the z-order of the replay content 404, and is assigned a z-order value incrementally higher than the highest z-order value of the strokes in the replay content 404 in the selected area of interest 402. In yet another example, the annotation 1304 shares the z-order with the position in the replay order in which it is added, to be made visible in conjunction with the replay content 404 displayed at that position in the z-order. According to an example, when a digital pen 1302 or other ink input device is detected within range of the replay content 404 while in replay mode, a selected tab in the command bar may be automatically switched to a draw tab 1306. According to another aspect, the user is enabled to interact with the replay content 404 while it is being replayed, such as to add, delete, or otherwise modify content and save the changes made while in replay mode.

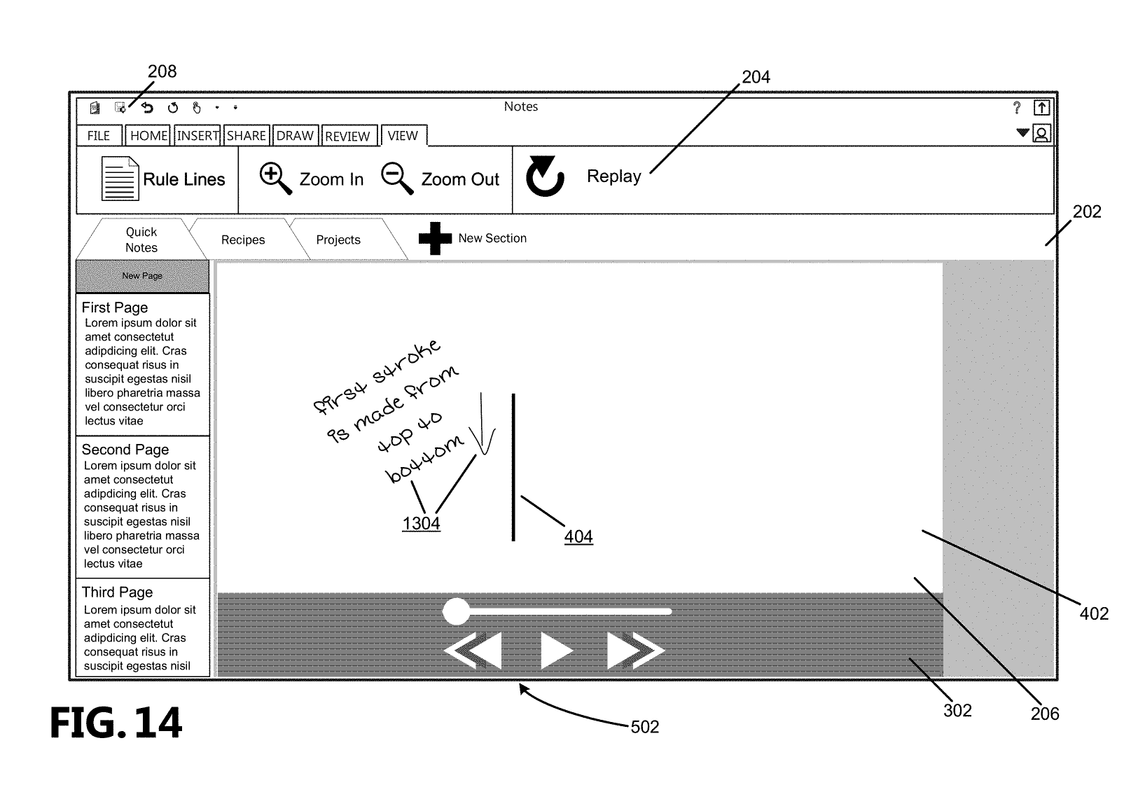

As another example of a situation in which it may be beneficial to a user to incrementally replay content includes learning to draw a Far East language character, such as a Kanji character, which is composed of specific strokes that are supposed to be made in a certain fashion and order. FIGS. 14-16 illustrate an example incremental revealing of strokes for drawing a Kanji character (e.g., the Kanji character for “mouth”— [symbol] ). As illustrated in FIGS. 14-16, the replay content 404 includes previously-added annotations 1304 that are added to the z-order and incrementally displayed with the replay content 404. When an annotation is added to the z-order, it may share the z-order value for the position during the replay in which it was added or may be assigned a unique z-order value between the currently displayed and the elements that will next be displayed (forward in the z-order when the replay mode is forward and backward in the z-order when the replay mode is backward).

Annotations 1304 have a visible display state when the replay reaches their position in the replay order, but have a hidden display state at other times during the replay, as is illustrated in FIGS. 14-16 where each annotation 1304 is displayed during the replay while a relevant piece of content 404 is added to the display. In other aspects, a user may set an annotation 1304 to persist across several portions of the content 404 being replayed, such that a given annotation 1304 may be displayed throughout the replay order or for a designated portion of the replay order.

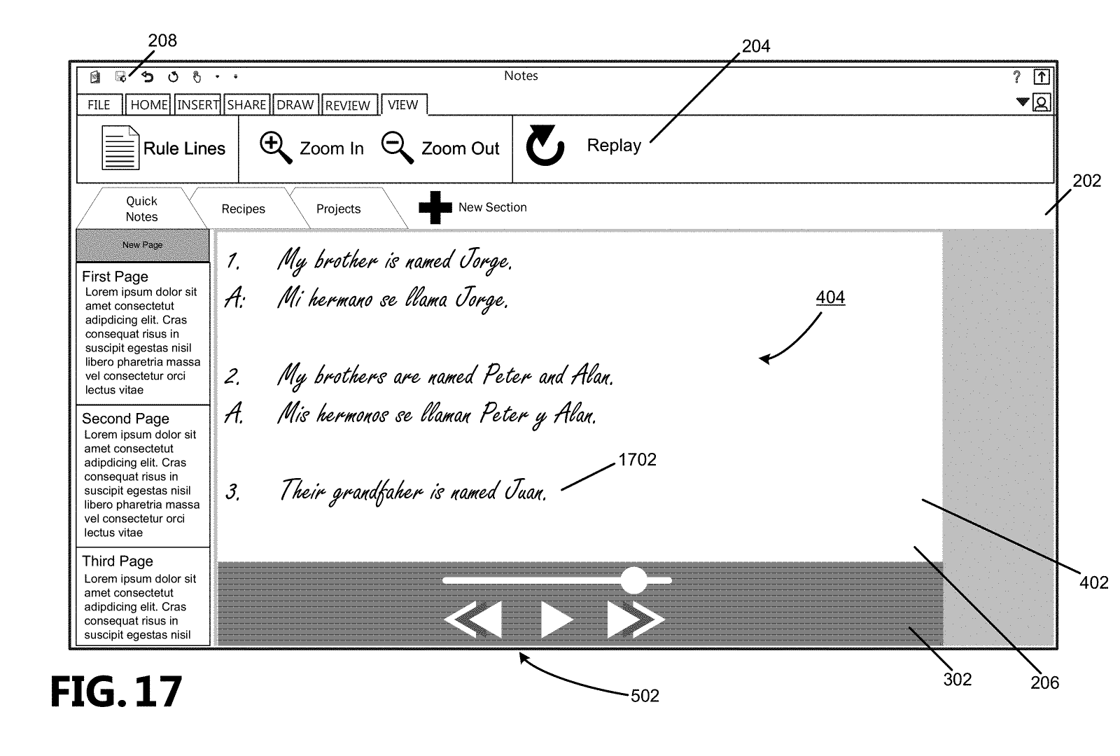

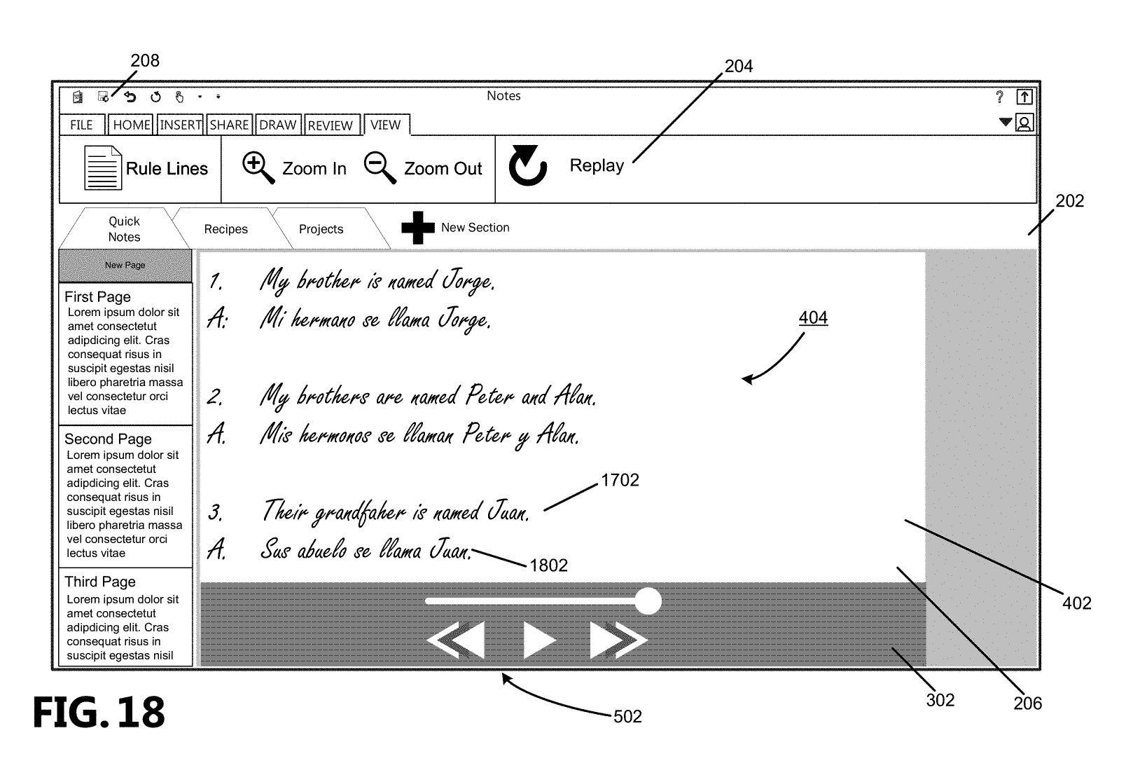

As another example of a situation in which it may be beneficial to a user to incrementally replay content includes students testing/quizzing themselves to study or a teacher lecturing from prepared content. For example, as illustrated in FIG. 17, a teacher teaching Spanish may prepare lecture notes that include a sentence in English 1702. The teacher may wish to incrementally reveal the replay content 404 to enable students to try to answer before revealing the answer 1802, as illustrated in FIG. 18.

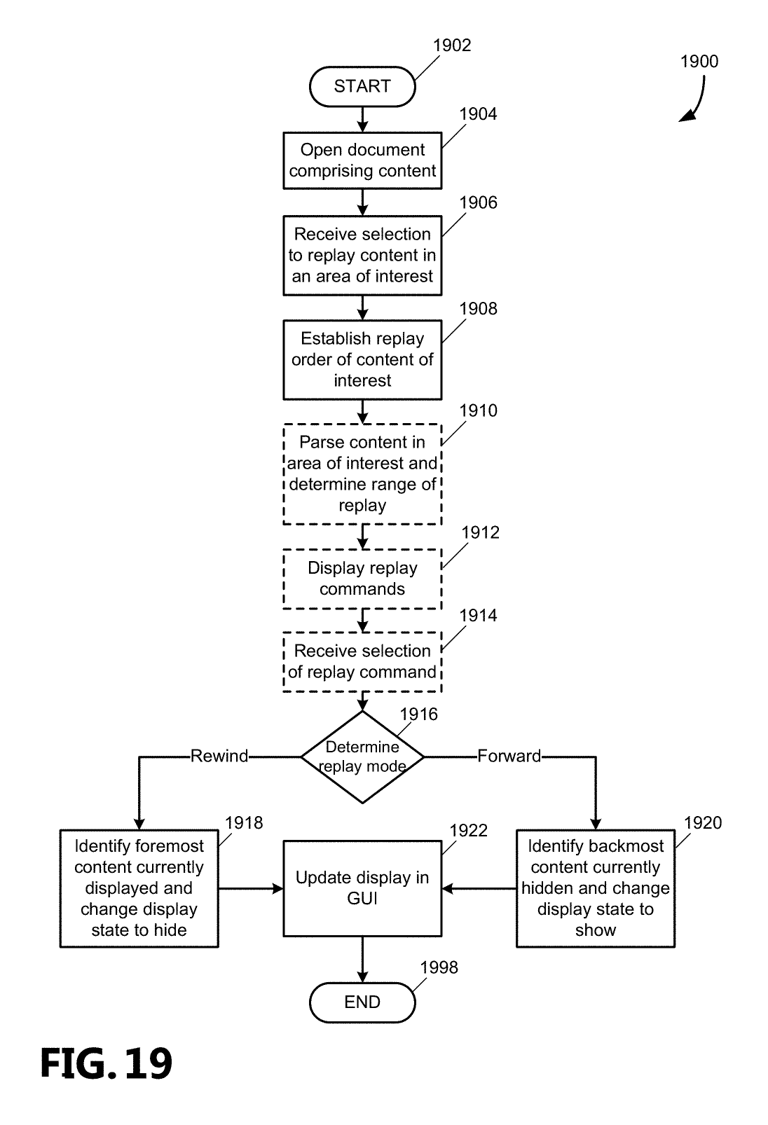

Having described an example operating environment and various examples, FIG. 19 is a flowchart showing general stages involved in an example method 1900 for providing incremental revealing and hiding of content. Method 1900 begins at OPERATION 1902, and proceeds to OPERATION 1904, where a document is loaded, wherein the document includes content, such as textual content, numerical content, digital ink stroke inputs, graphical content, and the like.

The method 1900 proceeds to OPERATION 1906, where a selection to replay content in an area of interest 402 is received. For example, a user may select a “Replay” entry point 204 command and may then make a selection of a portion of content displayed on the canvas 206, or may select to replay everything on the page or everything currently displayed on the canvas 206.

The method 1900 proceeds to OPERATION 1908, where a replay order of the content of interest (i.e., replay content or content that is located in the selected area of interest 402) is established. For example, the content is assigned a replay-order value. In one example, the replay-order value is based on the content's structural hierarchy in back-to-front order (i.e., z-order). It is possible in this case that ordering is implicit in existing structure, and no computation is required as this stage. In another example, the replay-order value is based on a timestamp associated with a modification (e.g., input) of the content. Accordingly, newer or more recently added input has a higher replay-order value, and older or previously added input has a lower replay-order value. In another example, replay order value is based on a combination of structural hierarchy and timestamp association. For example, an object that was first added to the canvas 206, may have been modified at a later time to adjust its display properties (e.g., a spelling correction, a size/color/font adjustment, a theme application) and the replay-order may treat the modification as a separate element to display during replay or incorporate the modification when the object is first displayed during replay.

In various aspects, the user may set whether the z-order for replays includes or excludes display property changes for objects as part of the z-order. For example, when display property changes are included in the z-order, when the replay reaches the display property change the display property change will be applied (forward replay mode) or removed (backward replay mode). When the display property changes are excluded from the z-order, objects that are made visible will be displayed with their last-applied display properties.

The method 1900 continues to OPTIONAL OPERATION 1910, where the content in the selected area of interest 402 is parsed, and the content elements within the selected area are counted, providing a range of replay from the beginning to the end. In some examples, the range of replay can be used to update the GUI to include replay functionality UI controls, such as a slider control (e.g., scrub bar 510) showing a range of steps. At OPTIONAL OPERATION 1912, one or more replay functionality UI controls (e.g., replay commands 502) are displayed, and at OPTIONAL OPERATION 1914, a selection of a replay command 502 is received. For example, a user may select the rewind command 508, the fast forward command 506, the play/pause command 504, a position along the scrub bar 510, provide keyboard input, etc. As should be appreciated, this operation is optional. For example, a replay mode (forward or backward) may be implicitly established via a user input (e.g., via a selection of a button or mouse wheel+ctrl+shift), and UI functionality controls may not be provided.

The method 1990 continues to a DECISION OPERATION 1916, where a determination of a replay mode is made. In some examples, the determination is made based on a selected replay command 502. If the replay mode is determined to be backward, for example, the rewind command 508 is selected, the scrub bar 510 is selected or moved in a backward direction indicating a selection to play previous content, etc., the method 1900 continues to OPERATION 1918, where the foremost content that is currently displayed according to the replay-order value is identified, and the display state of the content is changed to hidden so as to incrementally hide the content.

If the replay mode is determined to be forward, for example, the fast forward command 506 is selected, the scrub bar 510 is selected or moved in a forward direction indicating a selection to play succeeding content, the play/pause command 504 is selected, etc., the method 1900 continues to OPERATION 1920, where the backmost content according to the replay-order value is identified, and the display state of the content is changed to visible. As will be appreciated, if the replay mode is determined to be forward and is designated to start at a given point (e.g., the beginning of the replay order) all content ahead of the given point will have its display state set to hidden.

The method 1990 continues to OPERATION 1922, where the display of the replay content 404 is updated in the GUI 202. When the determination made at DECISION OPERATION 1916 is that the selected command is the play/pause command 504, OPERATIONS 1920 and 1922 may repeat multiple times until each piece of content in the area of interest 402 is revealed so as to incrementally show the content.

Method 1900 may repeat OPERATIONS 1914-1922 multiple times according to a number of times the user selects to hide or reveal content in the selected area of interest. The method 1900 ends at OPERATION 1998. Method 1900 may be repeated continuously or a predetermined number of times with the same or opposite replay modes to loop the replay of the content or walk back and forth through the replay order.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

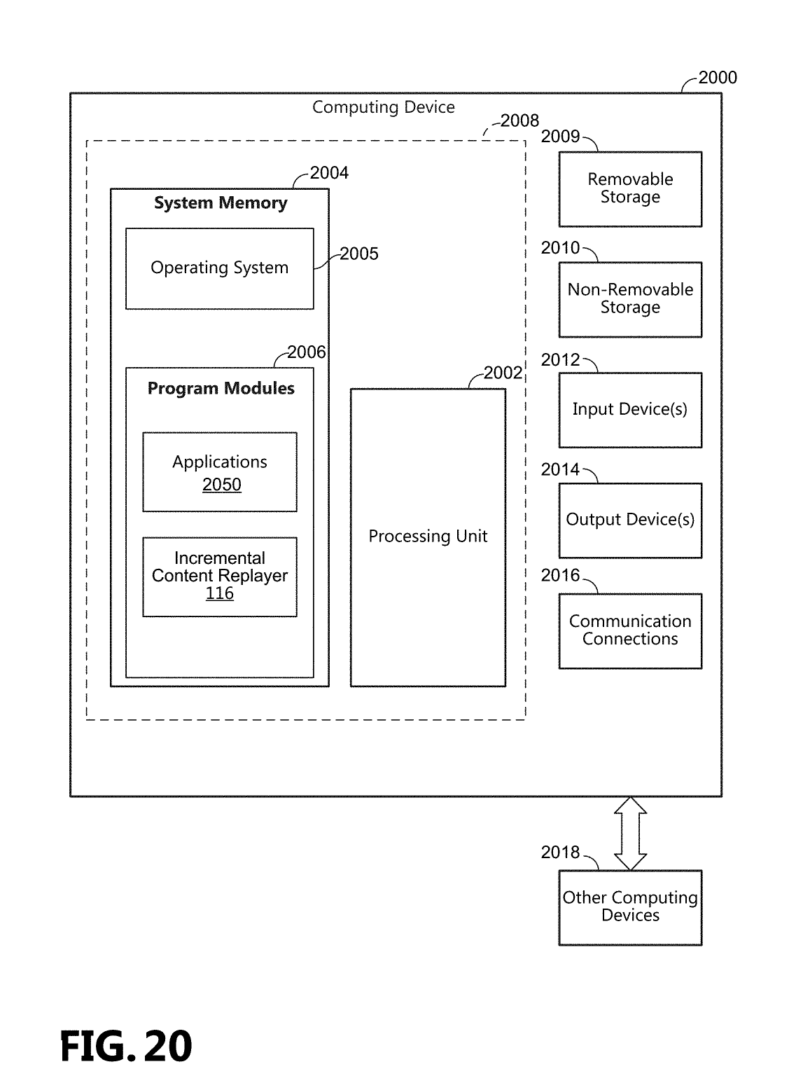

FIGS. 20-22 and the associated descriptions provide a discussion of a variety of operating environments in which examples are practiced. However, the devices and systems illustrated and discussed with respect to FIGS. 20-22 are for purposes of example and illustration and are not limiting of a vast number of computing device configurations that are used for practicing aspects, described herein.

FIG. 20 is a block diagram illustrating physical components (i.e., hardware) of a computing device 2000 with which examples of the present disclosure may be practiced. In a basic configuration, the computing device 2000 includes at least one processing unit 2002 and a system memory 2004. According to an aspect, depending on the configuration and type of computing device, the system memory 2004 comprises, but is not limited to, volatile storage (e.g., random access memory), non-volatile storage (e.g., read-only memory), flash memory, or any combination of such memories. According to an aspect, the system memory 2004 includes an operating system 2005 and one or more program modules 2006 suitable for running software applications 2050. According to an aspect, the system memory 2004 includes an incremental content replayer 116, operable to enable a software application 2050 to employ the teachings of the present disclosure via stored instructions. The operating system 2005, for example, is suitable for controlling the operation of the computing device 2000. Furthermore, aspects are practiced in conjunction with a graphics library, other operating systems, or any other application program, and is not limited to any particular application or system. This basic configuration is illustrated in FIG. 20 by those components within a dashed line 2008. According to an aspect, the computing device 2000 has additional features or functionality. For example, according to an aspect, the computing device 2000 includes additional data storage devices (removable and/or non-removable) such as, for example, magnetic disks, optical disks, or tape. Such additional storage is illustrated in FIG. 20 by a removable storage device 2009 and a non-removable storage device 2010.

As stated above, according to an aspect, a number of program modules and data files are stored in the system memory 2004. While executing on the processing unit 2002, the program modules 2006 (e.g., incremental content replayer 116) perform processes including, but not limited to, one or more of the stages of the method 1900 illustrated in FIG. 19. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 2000 has one or more input device(s) 2012 such as a keyboard, a mouse, a pen, a sound input device, a touch input device, etc. The output device(s) 2014 such as a display, speakers, a printer, etc. are also included according to an aspect. The aforementioned devices are examples and others may be used. According to an aspect, the computing device 2000 includes one or more communication connections 2016 allowing communications with other computing devices 2018. Examples of suitable communication connections 2016 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 2004, the removable storage device 2009, and the non-removable storage device 2010 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 2000. According to an aspect, any such computer storage media is part of the computing device 2000. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

FIGS. 21A and 21B illustrate a mobile computing device 2100, for example, a mobile telephone, a smart phone, a tablet personal computer, a laptop computer, and the like, with which aspects may be practiced. With reference to FIG. 21A, an example of a mobile computing device 2100 for implementing the aspects is illustrated. In a basic configuration, the mobile computing device 2100 is a handheld computer having both input elements and output elements. The mobile computing device 2100 typically includes a display 2105 and one or more input buttons 2110 that allow the user to enter information into the mobile computing device 2100. According to an aspect, the display 2105 of the mobile computing device 2100 functions as an input device (e.g., a touch screen display). If included, an optional side input element 2115 allows further user input. According to an aspect, the side input element 2115 is a rotary switch, a button, or any other type of manual input element. In alternative examples, mobile computing device 2100 incorporates more or fewer input elements. For example, the display 2105 may not be a touch screen in some examples. In alternative examples, the mobile computing device 2100 is a portable phone system, such as a cellular phone. According to an aspect, the mobile computing device 2100 includes an optional keypad 2135. According to an aspect, the optional keypad 2135 is a physical keypad. According to another aspect, the optional keypad 2135 is a “soft” keypad generated on the touch screen display. In various aspects, the output elements include the display 2105 for showing a graphical user interface (GUI), a visual indicator 2120 (e.g., a light emitting diode), and/or an audio transducer 2125 (e.g., a speaker). In some examples, the mobile computing device 2100 incorporates a vibration transducer for providing the user with tactile feedback. In yet another example, the mobile computing device 2100 incorporates a peripheral device port 2140, such as an audio input (e.g., a microphone jack), an audio output (e.g., a headphone jack), and a video output (e.g., a HDMI port) for sending signals to or receiving signals from an external device.

FIG. 21B is a block diagram illustrating the architecture of one example of a mobile computing device. That is, the mobile computing device 2100 incorporates a system (i.e., an architecture) 2102 to implement some examples. In one example, the system 2102 is implemented as a “smart phone” capable of running one or more applications (e.g., browser, e-mail, calendaring, contact managers, messaging clients, games, and media clients/players). In some examples, the system 2102 is integrated as a computing device, such as an integrated personal digital assistant (PDA) and wireless phone.

According to an aspect, one or more application programs 2150 are loaded into the memory 2162 and run on or in association with the operating system 2164. Examples of the application programs include phone dialer programs, e-mail programs, personal information management (PIM) programs, word processing programs, spreadsheet programs, Internet browser programs, messaging programs, and so forth. According to an aspect, incremental content replayer 116 is loaded into memory 2162. The system 2102 also includes a non-volatile storage area 2168 within the memory 2162. The non-volatile storage area 2168 is used to store persistent information that should not be lost if the system 2102 is powered down. The application programs 2150 may use and store information in the non-volatile storage area 2168, such as e-mail or other messages used by an e-mail application, and the like. A synchronization application (not shown) also resides on the system 2102 and is programmed to interact with a corresponding synchronization application resident on a host computer to keep the information stored in the non-volatile storage area 2168 synchronized with corresponding information stored at the host computer. As should be appreciated, other applications may be loaded into the memory 2162 and run on the mobile computing device 2100.

According to an aspect, the system 2102 has a power supply 2170, which is implemented as one or more batteries. According to an aspect, the power supply 2170 further includes an external power source, such as an AC adapter or a powered docking cradle that supplements or recharges the batteries.

According to an aspect, the system 2102 includes a radio 2172 that performs the function of transmitting and receiving radio frequency communications. The radio 2172 facilitates wireless connectivity between the system 2102 and the “outside world,” via a communications carrier or service provider. Transmissions to and from the radio 2172 are conducted under control of the operating system 2164. In other words, communications received by the radio 2172 may be disseminated to the application programs 2150 via the operating system 2164, and vice versa.

According to an aspect, the visual indicator 2120 is used to provide visual notifications and/or an audio interface 2174 is used for producing audible notifications via the audio transducer 2125. In the illustrated example, the visual indicator 2120 is a light emitting diode (LED) and the audio transducer 2125 is a speaker. These devices may be directly coupled to the power supply 2170 so that when activated, they remain on for a duration dictated by the notification mechanism even though the processor 2160 and other components might shut down for conserving battery power. The LED may be programmed to remain on indefinitely until the user takes action to indicate the powered-on status of the device. The audio interface 2174 is used to provide audible signals to and receive audible signals from the user. For example, in addition to being coupled to the audio transducer 2125, the audio interface 2174 may also be coupled to a microphone to receive audible input, such as to facilitate a telephone conversation. According to an aspect, the system 2102 further includes a video interface 2176 that enables an operation of an on-board camera 2130 to record still images, video stream, and the like.

According to an aspect, a mobile computing device 2100 implementing the system 2102 has additional features or functionality. For example, the mobile computing device 2100 includes additional data storage devices (removable and/or non-removable) such as, magnetic disks, optical disks, or tape. Such additional storage is illustrated in FIG. 21B by the non-volatile storage area 2168.

According to an aspect, data/information generated or captured by the mobile computing device 2100 and stored via the system 2102 are stored locally on the mobile computing device 2100, as described above. According to another aspect, the data are stored on any number of storage media that are accessible by the device via the radio 2172 or via a wired connection between the mobile computing device 2100 and a separate computing device associated with the mobile computing device 2100, for example, a server computer in a distributed computing network, such as the Internet. As should be appreciated, such data/information are accessible via the mobile computing device 2100 via the radio 2172 or via a distributed computing network. Similarly, according to an aspect, such data/information are readily transferred between computing devices for storage and use according to well-known data/information transfer and storage means, including electronic mail and collaborative data/information sharing systems.

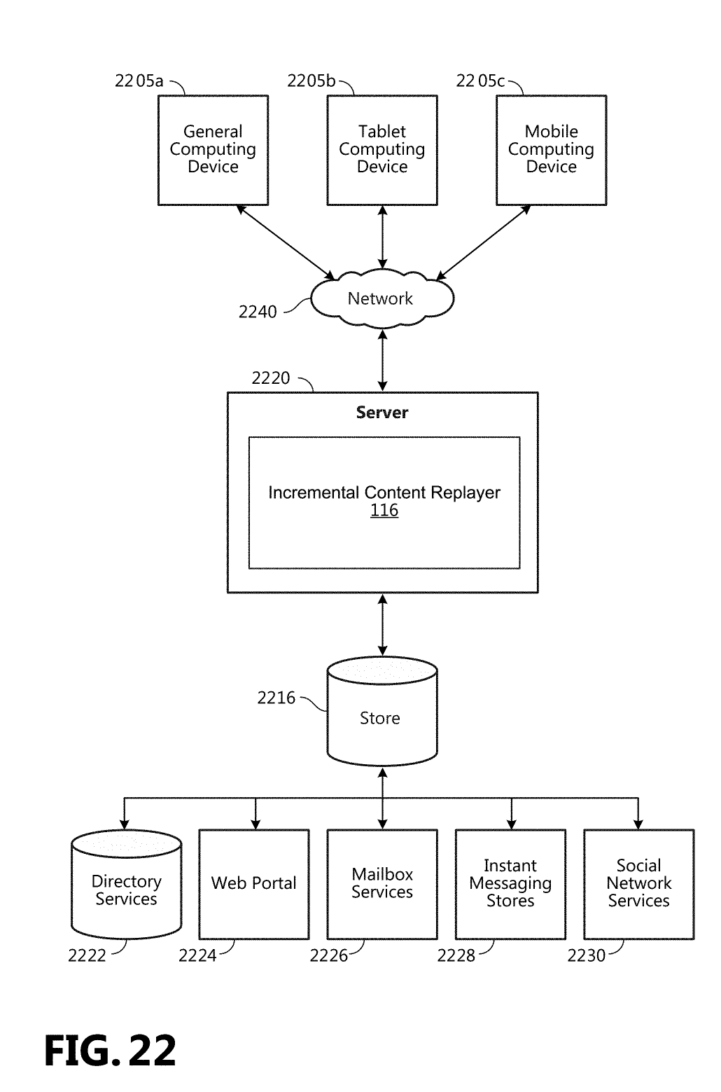

FIG. 22 illustrates one example of the architecture of a system for incremental replay of document content as described above. Content developed, interacted with, or edited in association with the incremental content replayer 116 is enabled to be stored in different communication channels or other storage types. For example, various documents may be stored using a directory service 2222, a web portal 2224, a mailbox service 2226, an instant messaging store 2228, or a social networking site 2230. The incremental content replayer 116 is operative to use any of these types of systems or the like for distribution of selected content, as described herein. According to an aspect, a server 2220 provides the incremental content replayer 116 to clients 2205a-c (generally clients 2205). As one example, the server 2220 is a web server providing the EAE 180 over the web. The server 2220 provides the incremental content replayer 116 over the web to clients 2205 through a network 2240. By way of example, the client computing device is implemented and embodied in a personal computer 2205a, a tablet computing device 2205b or a mobile computing device 2205c (e.g., a smart phone), or other computing device. Any of these examples of the client computing device are operable to obtain content from the store 2216.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A computer storage medium including instructions, which when executed by a computer, provide:
a productivity application;
an application programming interface for incrementally replaying content in a graphical user interface of the productivity application; and
an incremental content replayer, in communication with the productivity application via the application programming interface, operative to:
receive a selection of an area of interest in the graphical user interface for which to replay the content from the productivity application displayed therein, wherein the content is comprised of a plurality of content elements;
establish a replay order of the content in the area of interest;
receive an indication of a starting point and a replay mode;
when the replay mode is backward:
identify a foremost content element relative to the starting point currently displayed; and
change a display state of the foremost content element to hidden;
when the replay mode is forward:
identify a backmost content element relative to the starting point currently displayed; and
change a display state of the backmost content element to visible;
receive an annotation during replay of the content; and
assign the annotation to the replay order at a given position based on a current position of the replay order, wherein a display state for the annotation is visible at the given position and hidden at other positions in the replay order.

2. The computer storage medium of claim 1, wherein in establishing the replay order of the content in the area of interest, the incremental content replayer is operative to index each content element with a z-order value based on a hierarchical structure of the content in the area of interest within the productivity application.

3. The computer storage medium of claim 1, wherein in establishing the replay order of the content in the area of interest, the incremental content replayer is operative to index each content element with a z-order value based on a timestamp.

4. The computer storage medium of claim 1, wherein when the replay mode is forward the incremental content replayer is further operative to:
identify content elements from the plurality of content elements that are forward in the replay order relative to the starting point; and
set display states for the content elements that are forward in the replay order to hidden.

5. The computer storage medium of claim 1, wherein the plurality of content elements are grouped according smart grouping into characters.

6. The computer storage medium of claim 1, wherein in response to receiving the selection of the area of interest, the graphical user interface is further operable to display replay command user interface elements that are selectable to receive the indication of the starting point and the replay mode.

7. The computer storage medium of claim 6, wherein the replay command user interface elements are displayed proximate to the area of interest.

8. The computer storage medium of claim 6, wherein the replay command user interface elements include:
a scrub bar;
a play/pause command button;
a rewind command button; and
a fast forward command button.

9. A method for incrementally replaying content in a graphical user interface, comprising:
receiving a selection of an area of interest from which content is to be replayed, the content including a plurality of content elements;
establishing a replay order of the plurality of content elements;
receiving an indication of a starting point and a replay mode, wherein the replay mode is selected from forward and backward;
in response to the replay mode being backward:
identifying a foremost content element currently displayed in the area of interest relative to the starting point;
changing a display state of the foremost content element to hidden; and
updating the foremost content element according to the display state in the graphical user interface;
when the replay mode is forward:
identifying a backmost content element currently displayed in the area of interest relative to the starting point;
changing a display state of the backmost content element to visible; and
updating the backmost content element according to the display state in the graphical user interface;
receiving an annotation during replay of the content; and
assigning the annotation to the replay order at a given position based on a current position of the replay order, wherein a display state for the annotation is visible at the given position and hidden at other positions in the replay order.

10. The method of claim 9, wherein establishing the replay order of the content in the area of interest comprises indexing each content element with a z-order value based on hierarchical structure.

11. The method of claim 9, wherein establishing the replay order of the content in the area of interest comprises indexing each content element with a z-order value based on a timestamp.

12. The method of claim 9, wherein changes to display properties of the content are excluded from a z-order.

13. The method of claim 9, further comprising:
parsing the content in the area of interest and counting the plurality of content elements to provide a range of replay.

14. The method of claim 13, further comprising:
displaying a replay functionality in the graphical user interface according to the range of replay, the replay functionality operable to receive the indication of the starting point and the replay mode.

15. The method of claim 14, wherein the replay functionality is displayed in the graphical user interface proximate to the area of interest and includes a scrub bar indicating the starting point relative to the range of replay.

16. The method of claim 9, wherein in response to receiving the indication of the starting point, hiding each content element of the plurality of content elements ahead of the starting point in the replay order.

17. A system for incrementally replaying content in a graphical user interface, comprising:
an incremental content replayer comprising:
an input manager operative to receive a selection of an area of interest in the graphical user interface;
a replay order generator operative to identify content authored in the area of interest, the content comprising a plurality of content elements, and to establish a replay order of the plurality of content elements in the area of interest;
a state selector operative to:
determine a replay mode;
when the replay mode is backward:
identify a foremost content element according to the replay order that is currently displayed in the area of interest; and
hide the foremost content element from display in the graphical user interface;
when the replay mode is forward:
identify a backmost content element according to the replay order that is currently displayed in the area of interest;
change a display state of the backmost content element from hidden to visible;
receive new content elements authored in the area of interest at a current position of the replay order while replaying the content;
add the new content elements to the plurality of content elements in the replay order at the current position of replaying the content; and
a user interface engine operative to update the graphical user interface.

18. The system of claim 17, wherein hiding the foremost content element from display in the graphical user interface applies a reduced visibility effect to the foremost content element.

19. The system of claim 17, wherein when the replay mode is forward, all content elements of the plurality of content elements that ahead of the backmost content element according to the replay order are hidden from display in the graphical user interface.

20. The system of claim 17, wherein the new content elements are annotations whose display states are hidden except at the current position of the replay order, where the display states are set to visible by the state selector.
